(19) United States
(12) Patent Application Publication
(10) Pub. No.: US 2020/0213818 A1
(43) Pub. Date: Jul. 2, 2020

(54) RADIO-OVER-INTERNET-PROTOCOL (ROIP) GATEWAY TALK GROUP CONFIGURATION

(71) Applicant: Cubic Corporation, San Diego, CA (US)

(72) Inventors: Stephen Wilson, Shackleford (GB); Estelle Tidey, Shackleford (GB)

(73) Assignee: Cubic Corporation, San Diego, CA (US)

(21) Appl. No.: 16/727,287

(22) Filed: Dec. 26, 2019

Related U.S. Application Data
(60) Provisional application No. 62/786,191, filed on Dec. 28, 2018.

(51) Int. Cl. H04W 4/08

(52) U.S. Cl. CPC H04W 4/08

(57) ABSTRACT

A Radio Over Internet Protocol (RoIP) device can efficiently create a talk group by utilizing a graphical user interface (GUI). Configuration information is obtained via user interaction with the GUI, which can lead the user through a logical series of screens to quickly and efficiently obtain the configuration information for the talk group. The configuration information may comprise audio port selection information, address-streaming information, Session Initiation Protocol information, and/or audio codec information. This the RoIP gateway device can then set up the talk group such as that communication between devices and the talk group occurs in accordance with the configuration information received by the user.

### CROSS-REFERENCES TO RELATED APPLICATIONS

This application is a nonprovisional of and claims the benefit of priority to U.S. Provisional Patent Application No. 62/786,191, filed Dec. 28, 2018, entitled “RADIO GATEWAY TALK GROUP CONFIGURATION,” the entire contents of which are herein incorporated by reference.

### BACKGROUND

Radio-over-Internet-Protocol (RoW) is a technology that allows two-way radio communication between different radio and other communication platforms. Similar to Voice over IP (VoIP), RoIP can be deployed over private and/or public data communication networks (e.g., the Internet), which may utilize any of a variety of wired and/or wireless technologies (in addition to radio technologies utilized between radio handsets). Unlike VoIP, however, RoIP may additionally enable push-to-talk (PTT) functionality. Communications may be half- or full-duplex, depending on desired functionality and the capabilities of the various components of a RoW system. Because RoW uses a data communication network backbone to bridge various radio platforms, it can not only enable radio handsets to communicate with other types of radio handsets (e.g., radio handsets utilizing different frequencies), but it can also enable radio handsets to communicate with other types of non-radio devices, which may be far beyond the reach of a radio signal. With this functionality, RoIP can be extremely useful to first responders and others who frequently communicate using radios.

A RoIP gateway device (also referred to herein as a radio gateway) that lies at the heart of a RoIP system can be configured to divide devices connected to the RoIP system into “talk groups.” Devices in a talk group can communicate with other devices within a talk group. And if multiple talk groups are set up, communication within talk groups can be shielded from other talk groups, preventing interference between talk groups. Thus, a RoIP gateway device configured with multiple talk groups can allow a RoIP system to enable multiple types of users (e.g., different types of emergency services, different military platoons, etc.) to communicate with each other across the same RoIP system, without communication interference among groups.

### BRIEF SUMMARY

Embodiments disclosed herein provide for efficient talk group creation by a RoIP gateway device via a graphical user interface (GUI) in which configuration information is obtained via user interaction with the GUI, which can lead the user through a logical series of screens to quickly and efficiently obtain the configuration information for the talk group. The configuration information may comprise audio port selection information, address-streaming information, Session Initiation Protocol information, and/or audio codec information. This the RoIP gateway device can then set up the talk group such as that communication between devices and the talk group occurs in accordance with the configuration information received by the user.

An example method of configuring a talk group with a Radio-over-Internet-Protocol (RoIP) gateway device, according to this disclosure, comprises providing a Graphical User Interface (GUI), receiving configuration information via user interaction with the GUI. The configuration information comprises audio port selection information indicative of one or more audio ports of the RoIP gateway device to include in the talk group, address-streaming information indicative of one or more destinations to which an audio stream of the talk group is to be sent, Session Initiation Protocol (SIP) information indicative of whether SIP is selected for use in the talk group, and audio codec information indicative of a selected audio codec for the talk group. The method further comprises creating a talk group with the RoIP gateway device, wherein communication within the talk group uses the one or more audio ports, comprises streaming audio to the one or more destinations, and uses the selected audio codec.

An example RoIP gateway device, according to this disclosure, comprises a communications subsystem a memory, and one or more processors communicatively coupled with the memory and communications system The one or more processors are configured to provide a Graphical User Interface (GUI), receive configuration information via user interaction with the GUI. The configuration information comprises audio port selection information indicative of one or more audio ports of the RoIP gateway device to include in a talk group, address-streaming information indicative of one or more destinations to which an audio stream of the talk group is to be sent, Session Initiation Protocol (SIP) information indicative of whether SIP is selected for use in the talk group, and audio codec information indicative of a selected audio codec for the talk group. The one or more processors are also configured to create a talk group using the communications subsystem such that communication within the talk group uses the one or more audio ports, comprises streaming audio to the one or more destinations, and uses the selected audio codec.

An example non-transitory computer-readable medium, according to this disclosure, has instructions stored thereby for operating a Radio-over-Internet-Protocol (RoIP) gateway device. The instructions, when executed by one or more processors, cause the one or more processors to provide a Graphical User Interface (GUI), and receive configuration information via user interaction with the GUI. The configuration information comprises audio port selection information indicative of one or more audio ports of the RoIP gateway device to include in a talk group, address-streaming information indicative of one or more destinations to which an audio stream of the talk group is to be sent, Session Initiation Protocol (SIP) information indicative of whether SIP is selected for use in the talk group, and audio codec information indicative of a selected audio codec for the talk group. The instructions, when executed by one or more processors, also cause the one or more processors to create a talk group using the RoIP gateway device such that communication within the talk group uses the one or more audio ports, comprises streaming audio to the one or more destinations, and uses the selected audio codec.

### BRIEF DESCRIPTION OF THE DRAWINGS

For a more complete understanding of this invention, reference is now made to the following detailed description of the embodiments as illustrated in the accompanying drawings, in which like reference designations represent like features throughout the several views and wherein:

FIG. 1 is a diagram of a RoIP system, according to an embodiment;

FIGS. 2A-9 are illustrations of different portions of a GUI that may provide a guided user configuration process to set up one or more talk groups using the RoIP gateway device, according to some embodiments;

FIG. 10 is a flow diagram of a method of configuring a talk group with a RoIP gateway device, according to an embodiment; and

FIG. 11 is a block diagram of a simplified computer system, according to an embodiment.

In the appended figures, similar components and/or features may have the same reference label. Further, various components of the same type may be distinguished by following the reference label by a dash and a second label that distinguishes among the similar components. If only the first reference label is used in the specification, the description is applicable to any or all of the similar components having the same first reference label irrespective of the second reference label.

### DETAILED DESCRIPTION

The ensuing description provides embodiments only, and is not intended to limit the scope, applicability or configuration of the disclosure. Rather, the ensuing description of the embodiments will provide those skilled in the art with an enabling description for implementing an embodiment. It is understood that various changes may be made in the function and arrangement of elements without departing from the scope

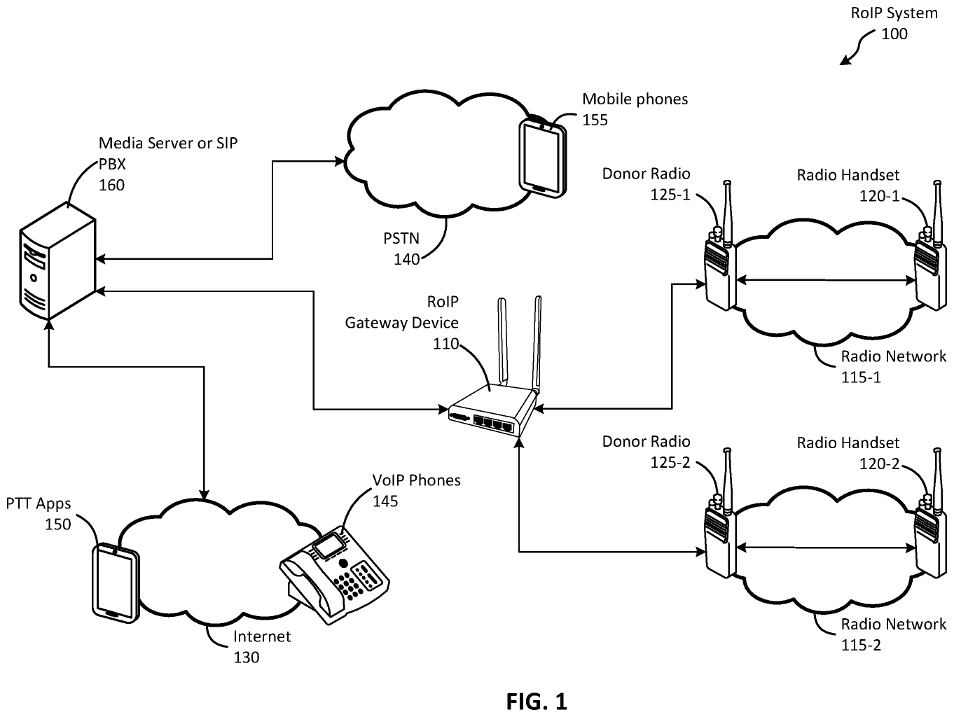

FIG. 1 is a diagram of a RoIP system 100, according to an embodiment. Here, a RoIP gateway device 110, can operate to provide audio communications between various connected devices of the RoIP system 100. (For a given audio transmission, the device originating the audio may be called the “audio source”, while other connected devices to which the audio is sent are called “audio endpoints.”) It will be understood that the various components provided in FIG. 1 are provided as examples. A RoIP system 100 may have more or fewer components, including any number of radio handsets 120 and/or other connected devices (VoIP phones 145, mobile phones 155, etc.). Moreover, the RoIP system 100 may have additional or alternative types of connected devices to those shown.

Two different radio networks 115-1 and 115-2 (collectively and generically referred to herein as radio networks 115), which may utilize different radio platforms (different manufacturers, protocols, frequencies, etc.). Thus, a radio handset 120-1 of a first radio network 115-1 may not be able to communicate directly with a radio handset 120-2 of a second radio network 115-2. The RoIP gateway device 110, however, can enable these radios 120 to communicate by acting as an intermediary. To do so, each radio network 115 can include a respective “donor radio” 125-1 and 125-2 (collectively and generically referred to herein as donor radios 125) that can both communicate with radio handsets 120 of the respective radio network 115, and also communicate with the RoIP gateway device 110 via a connection to a respective one of several audio ports of the RoIP gateway device 110, which can communicate audio and other signals with a donor radio 125 connected therewith. (According to some embodiments, these audio ports may comprise RJ45 ports.)

Data communicated between the RoIP gateway device 110 and donor radios 125 may vary, depending on desired functionality. In addition to audio (both transmit and receive), data can also include PTT and Carrier Operated Relay (COR) signaling, which can enable the PTT functionality. According to some embodiments, a custom cable may be used to connect an interface of each donor radio 125 (e.g., an ear piece jack) to an audio port of the RoIP gateway device 110.

To enable the radio handsets 120 to communicate to other types of devices and/or remote radio networks (not shown) the RoIP gateway device 110 can be coupled with a media server or Session Initiation Protocol (SIP) Private branch Exchange (PBX) 160 as illustrated. The media server or SIP PBX 160 can enable radio handsets 120 to communicate with Internet-connected devices via the Internet 130 (e.g., PTT apps 150 and VoIP phones 145), and/or devices connected to a public switched telephone network (PSTN) 140 (e.g., mobile phones 155).

With this communication capability, a RoIP system 100 can expand talk groups far beyond radio networks 115. Radio handsets 120 within a first radio network 115-1 tuned to the same frequency and within range of communication natively form a talk group in which the radios 120 may communicate with each other. The RoIP gateway device 110 allows for talk groups to extend beyond the first radio network 115-1 to other radio networks 115 that are directly connected with (e.g., a second radio network 115-2) or indirectly in communication with (e.g., via the Internet) the RoIP gateway device 110. The RoIP gateway device 110 further allows for talk groups to be formed with non-radio devices (e.g., VoIP phones 145, mobile phones 155, PTT apps 150, etc.). Thus, a talk group formed using the a RoIP gateway device 110 may be formed from devices (e.g., donor radios 125) connected to any or all of the audio ports of the RoIP gateway device 110 and endpoints (e.g., radios, phones, or other electronic devices, including devices connected with a remote RoIP gateway device in communication with the RoIP gateway device) connected to the RoIP system 100 that are listening and generating Real-time Transport Protocol (RTP) frames. The RoIP gateway device 110 itself can also be registered as a device to be dialed out of or dialed into, to extend PBX functionality.

Because the RoIP system 100 utilizes a variety of types of devices and network connections, traditional techniques for setting up a talk group on a RoIP gateway device 110 often involve complicated processes that can take a significant amount of time to complete. Oftentimes, a technician (typically from the manufacturer or distributor of the RoIP gateway devices) is needed to perform the setup. This can be a burdensome user and manufacturer/distributor alike.

Embodiments provided herein address these and other issues by providing a graphical user interface (GUI) for the RoIP gateway device 110 that allows for a relatively quick and easy creation of talk groups within the RoIP system 100. The GUI may comprise a webpage, which may be accessed by a user via an electronic device (not shown) executing a web browser application. The webpage may be hosted by a web server executed by the RoIP gateway device 110, and the web server may provide user inputs (e.g., as a submitted web form) to a RoIP application executed by the RoIP gateway device 110. The RoIP application may then operate to configure the RoIP gateway device 110 in accordance with the received user inputs. Depending on desired functionality, the electronic device used to access the GUI may be communicatively coupled with the RoIP gateway device 110 directly (e.g., direct wired or wireless means) or indirectly (e.g., via the Internet). An electric device may comprise, for example, a personal computer (PC), laptop, tablet, mobile phone, or the like. In some embodiments, the RoIP gateway device 110 may be capable of connecting directly with a monitor and/or input devices (e.g., keyboard, mouse, etc.) for providing user access to the GUI.

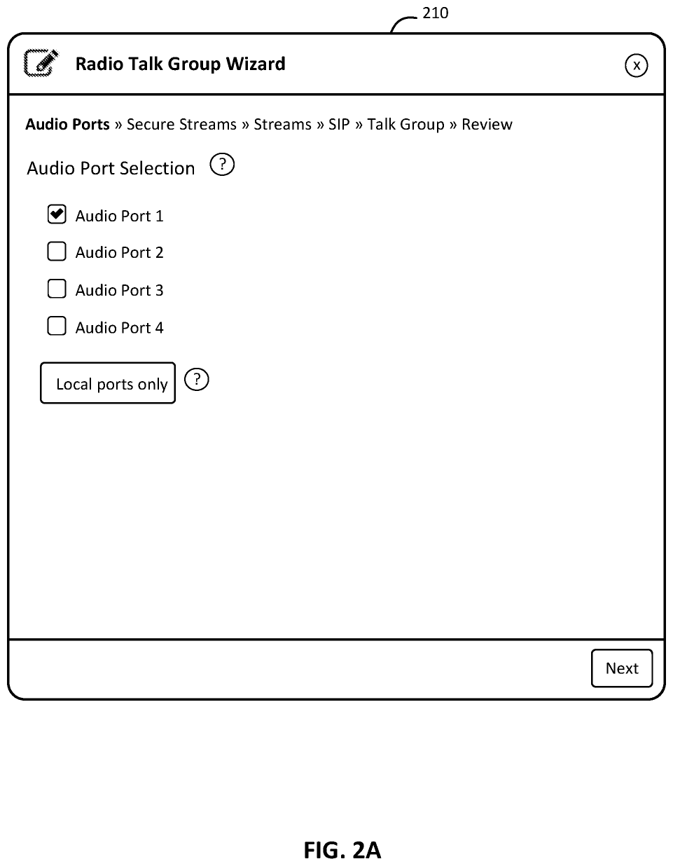

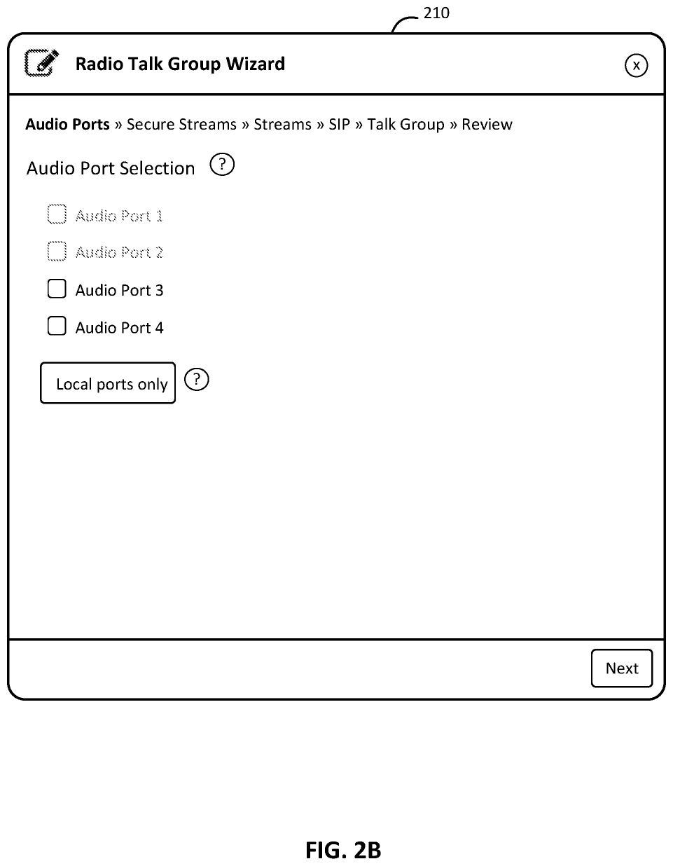

FIGS. 2A-9 are illustrations of portions (e.g., different screens) of a graphical user interface (GUI) that may provide a guided user configuration process to set up one or more talk groups using the RoIP gateway device 110, according to some embodiments. The user may navigate through these screens by selecting or entering information as discussed below and selecting the Next button to proceed to the next screen or Back button to return to the previous screen.

FIG. 2A is an illustration of an “Audio Ports” screen 210 displayed within the GUI in response to user input requesting the creation of a new talk group. As can be seen, the Audio

Ports screen 210 may be part of a series of screens (“Radio Talk Group Wizard”) that enables setup of a talk group. In the Audio Ports screen 210, all available audio ports of the RoIP gateway device 110 for use in a talk group may be listed. (Although four audio ports are shown, the number of audio ports may vary. A single RoIP gateway device 110 may have for audio ports, but it may be coupled with one or more expansion devices that may expand the number of audio ports to eight, 12, or more.)

To help minimize errors in the creation of a talk group, the GUI may be configured to prohibit a user from selecting options that may cause problems in view of other settings within the talk group and/or in other talk groups of the RoIP gateway device 110. FIG. 2B, for example, illustrates how the GUI may prevent a user from selecting Audio Ports 1 and 2 (which are grayed out and not selectable), if Audio Ports 1 and 2 are being used by another talk group.

In some embodiments, the GUI may allow a user to set up a talk group using only local audio ports. That is, according to some embodiments, the RoIP gateway device 110 can be configured to create a talk group that allows radio handsets 120 of different radio networks 115 to communicate with each other via donor radios 125 connected to different ports of the RoIP gateway device 110. (E.g., radio handset 120-1 radio network 115-1 of FIG. 1 may be communicatively coupled with radio handset 120-2 radio network 115-2.) In such embodiments, the GUI may allow a user to select creating a talk group using “local ports only.” (When a talk group using only local audio ports is selected, the GUI may allow a user to skip several portions of the setup process for the RoIP gateway device 110 that are applicable only when non-local ports are used.)

Using only local ports to create a talk group may be all that is needed in certain applications. For example, a first radio network 115-1 may comprise a police radio network, and a second radio network 115-2 may comprise an ambulance radio network. As such, creating a talk group with only two local audio ports may be all that is needed to allow police and ambulance radios to communicate with each other via the RoIP gateway device 110. That said, any applications can utilize additional functionality provided herein.

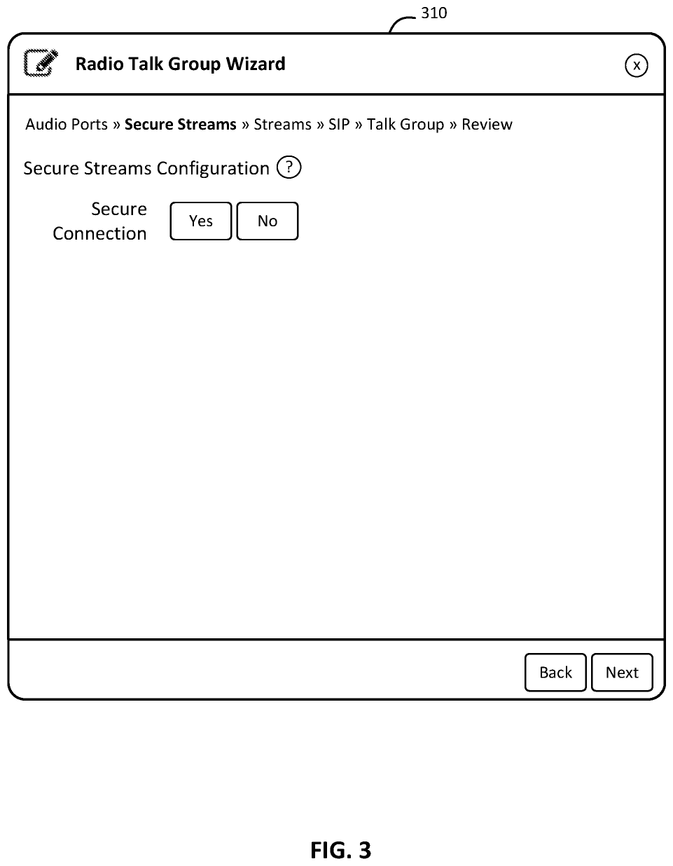

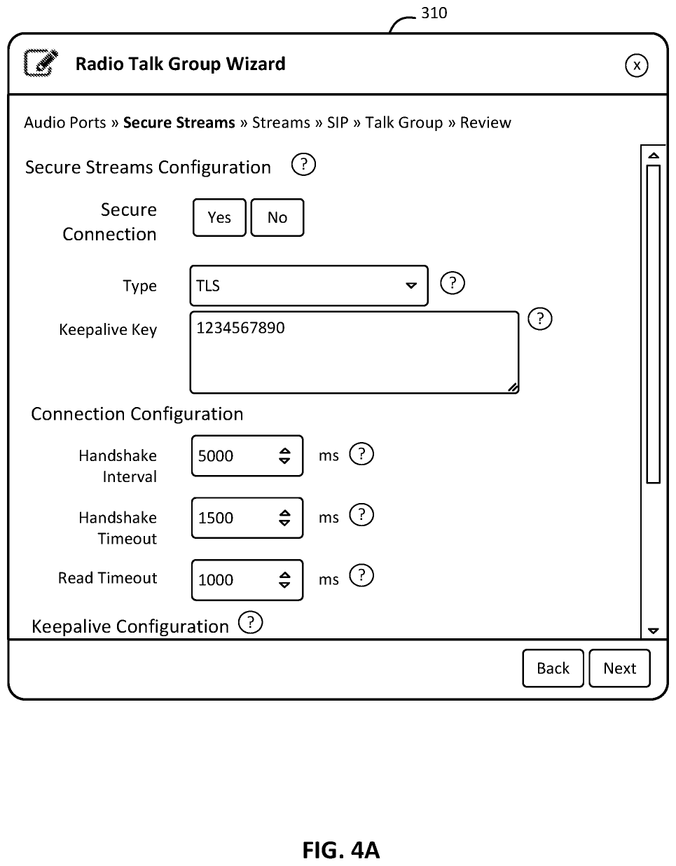

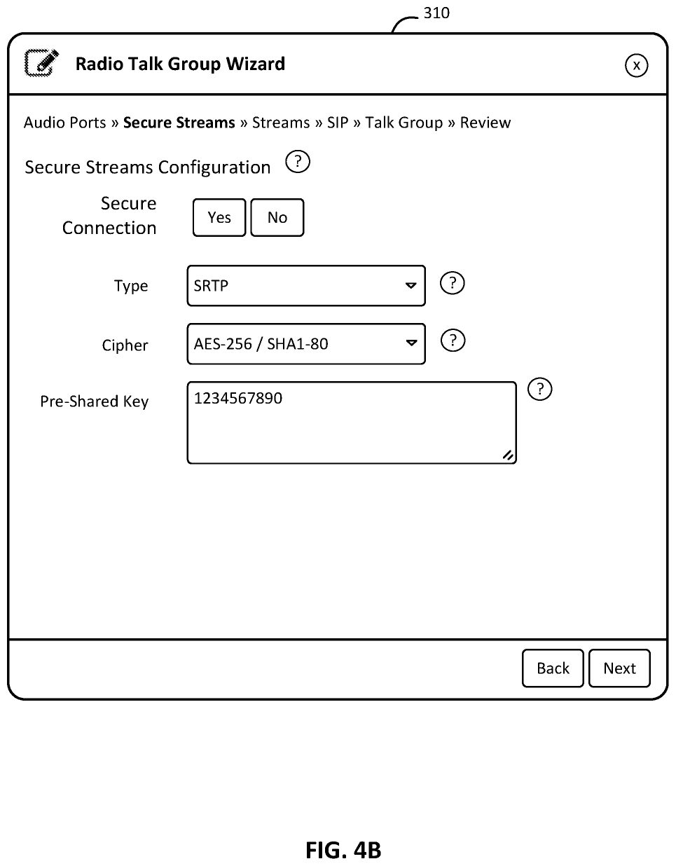

FIG. 3 is an illustration of a “Secure Streams” screen 310 within the GUI that allows a user to select whether to use a secure connection for the talk group. In this portion of the GUI, options provided to a user may vary, depending on whether a user selects Yes or No. If the user selects Yes, additional options may be provided on the Secure Streams screen 310, as illustrated in FIGS. 4A and 4B. This includes setting a security Type (e.g., Transport Layer Security (TLS), Datagram TLS (DTLS), Secure Real-Time Transport Protocol (SRTP) or the like). Additional options may vary, depending on the Type selected. For example, in FIG. 4A, the security Type selected is TLS, in which case a user is allowed to further input a Keepalive Key, Handshake Interval, Handshake Timeout, Read Timeout, and more. On the other hand, in FIG. 4B, where the Type is SRTP, the user is allowed to select a Cipher and input a Pre-Shared Key.

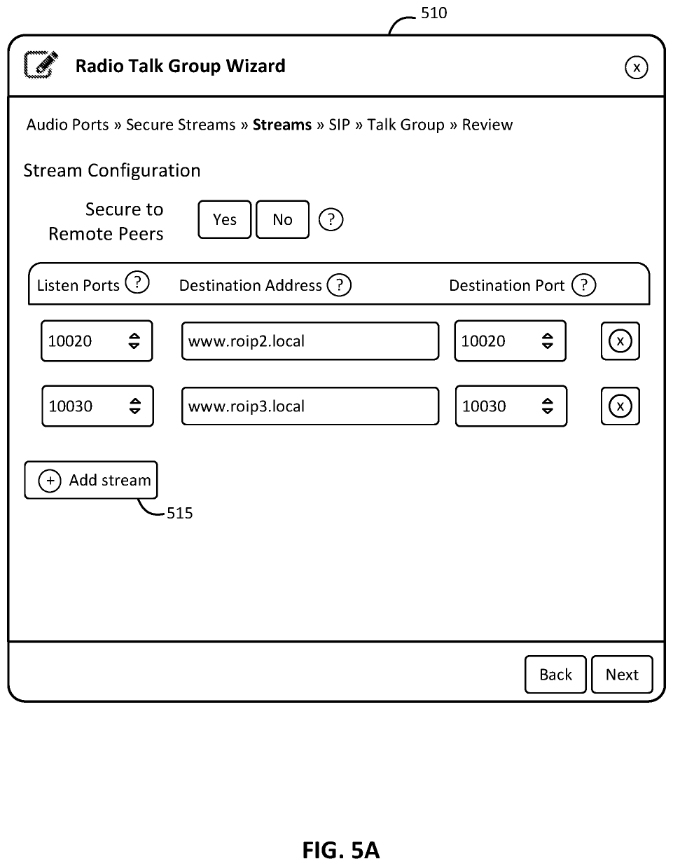

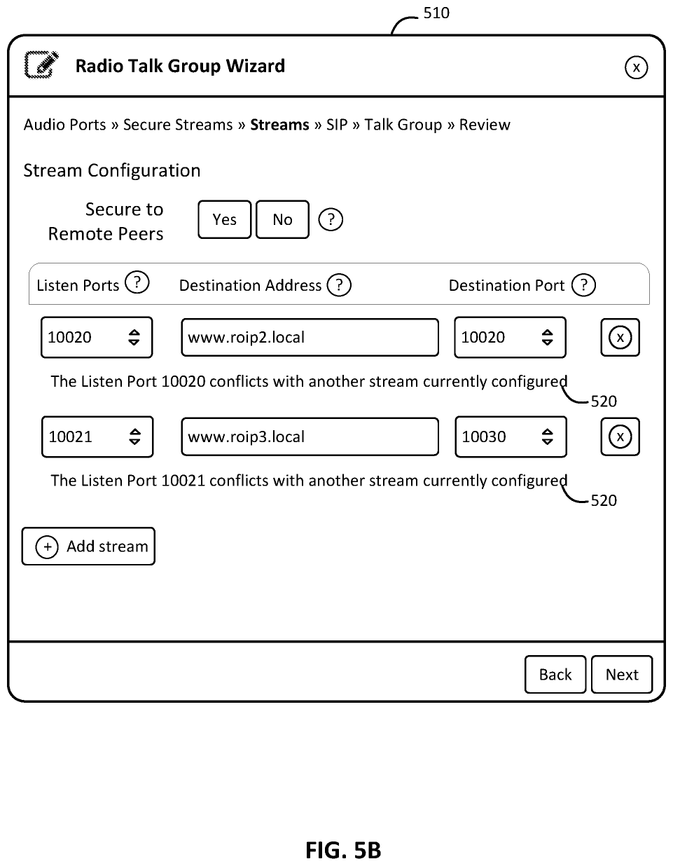

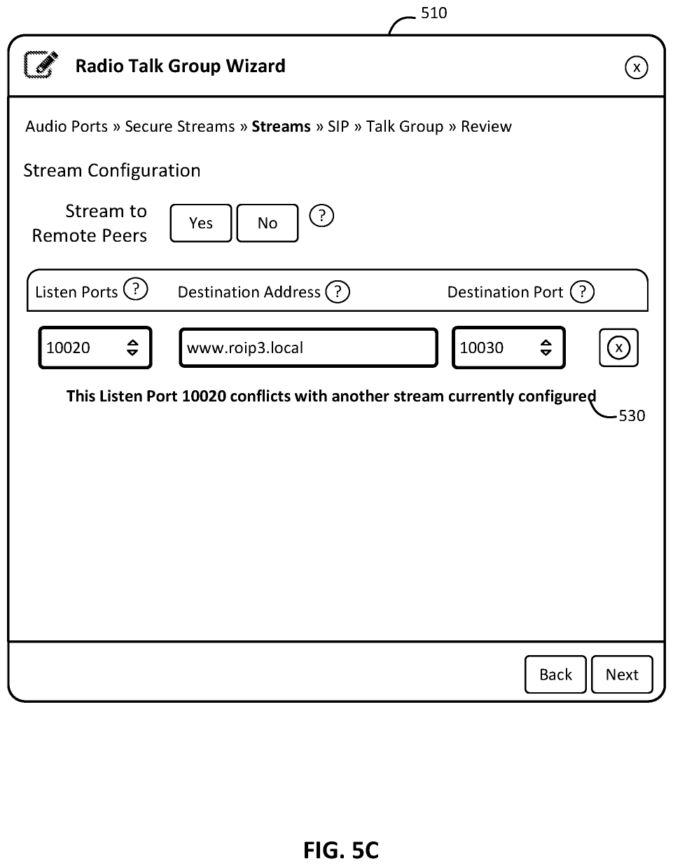

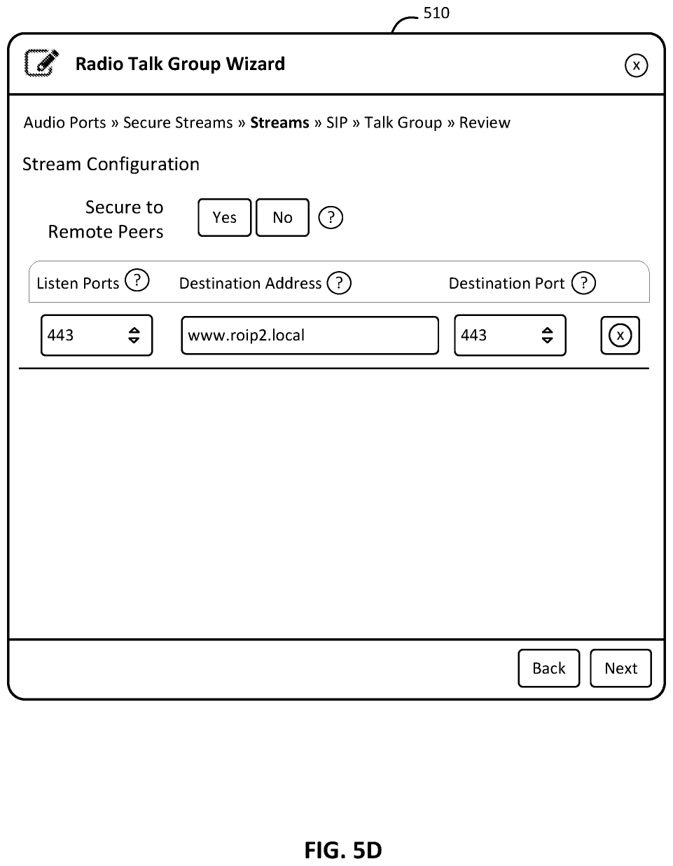

If the user selects No to using a secure connection, the user may then be taken to a “Streams” screen 510 of the GUI, as shown in FIG. 5A. Here a user is able to input information about a stream to include in the talk group by entering information into the fields that appear upon selecting the Add stream button 515. As illustrated, these fields include Listen Ports, Destination Address, and Destination Port. In the Destination Address field, the user may provide an IP address or a Domain Name System (DNS) location, indicating location to which audio from the talk group is to be streamed. A talk group can be configured with multiple streams with any unused listen port.

Again, the GUI can be configured to prevent the user from entering information that could result in problematic functionality. As illustrated in FIG. 5B, for example, if a listen port entered by a user conflicts with another listen port of the talk group, the GUI can indicate the conflict to the user (using one or more error messages 520), and prevent the user from proceeding before addressing the conflict by renumbering the listen port or removing a stream with a conflicting listen port. As illustrated in FIG. 5C, the Streams screen 510 can provide a similar error message 530 to the user when a listen port conflicts with a listen port used by another talk group.

In some embodiments, the Streams screen 510 may include a preconfigured setting, based on a type of security selected in the Secure Streams screen 310. For example, FIG. 5D illustrates an example preconfigured setting (443) shown in the Streams screen 510 for Listen and Destination Ports if the user selects the TLS security type. Moreover, depending on desired functionality, a user may be unable to change these preconfigured settings if they are required for a particular security type (e.g., TLS).

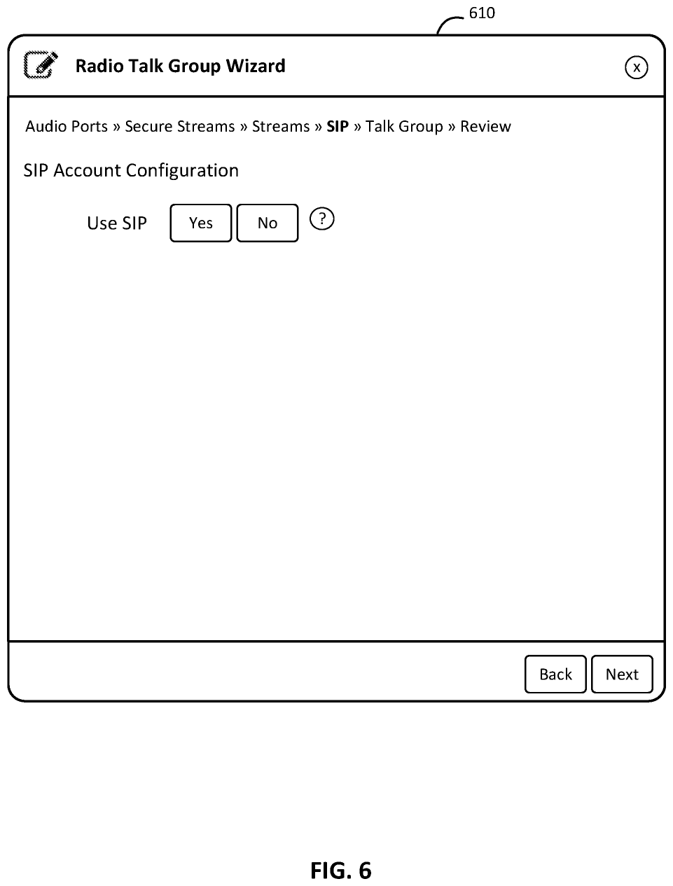

FIG. 6 is an illustration of an “SIP” screen 610 within the GUI. Here, the user can select whether to use SIP. If the user selects No, the GUI can proceed to the next screen. Alternatively, if the user selects Yes, the GUI can proceed to provide the user with additional options for configuring the talk group to use SIP.

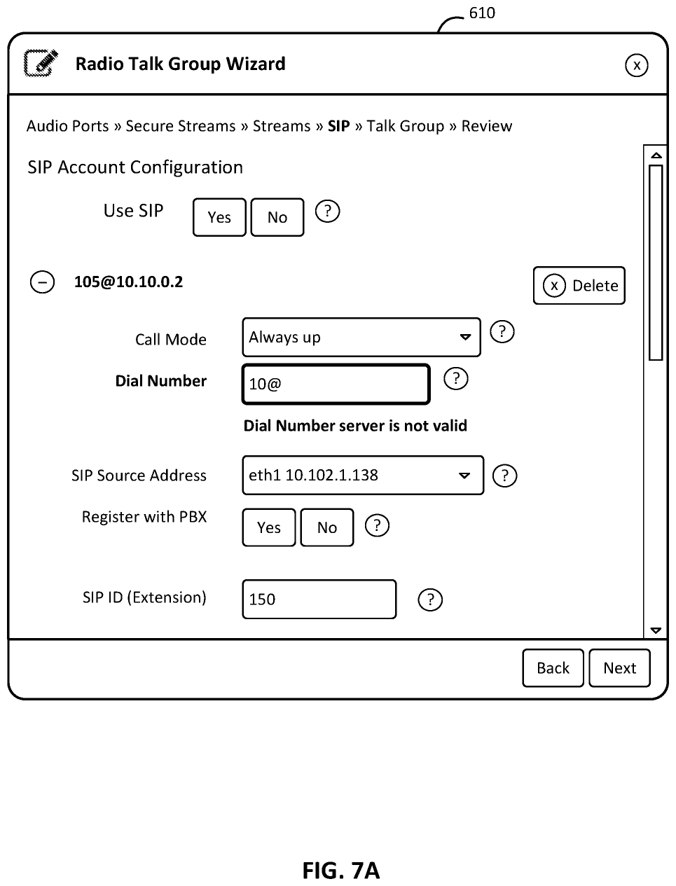

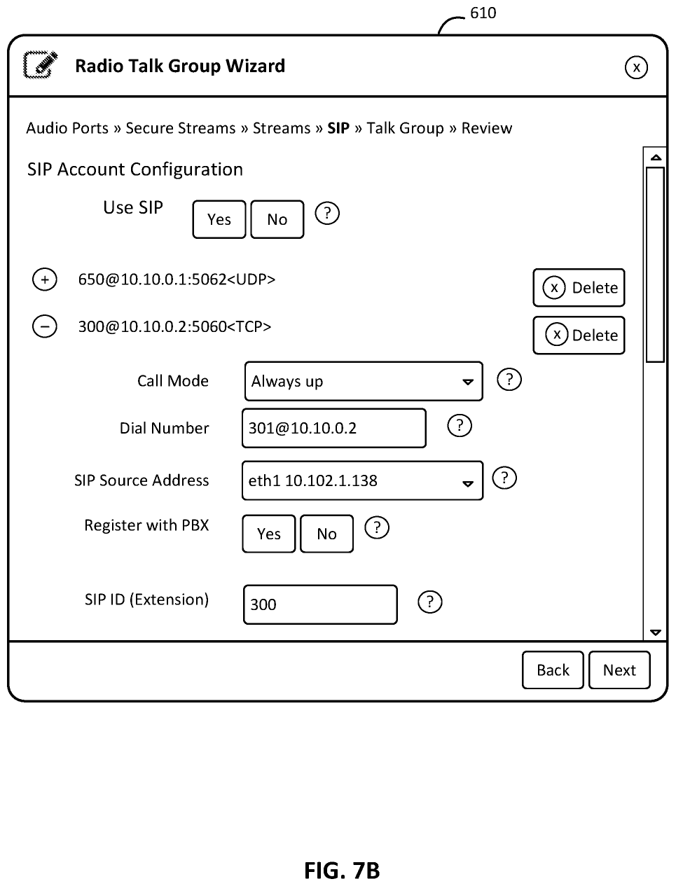

FIG. 7A, for example, shows additional options in the SIP screen 610 that can be shown if the user selects Yes. Once a user inputs information regarding a SIP account, the user may add additional SIP accounts, as illustrated in FIG. 7B. Configuration settings for SIP accounts can vary, and may include information as illustrated in FIGS. 7A and 7B. This can include, without limitation, a Dial Number, a Call Mode (e.g., incoming only, always up, voice activity detection, COR signaling, and Dual-Tone Multi-Frequency (DTMF), for example), a SIP Source Address, a SIP ID (extension), a PBX Address, a PBX SIP Port, and the like. Again, before the user is allowed to proceed with the talk group set up, the GUI can conduct a check for errors in user inputs. As indicated in FIG. 7A, for example, the GUI can prompt a user to reenter a dial number server if it determines the dial number server entered is not valid.

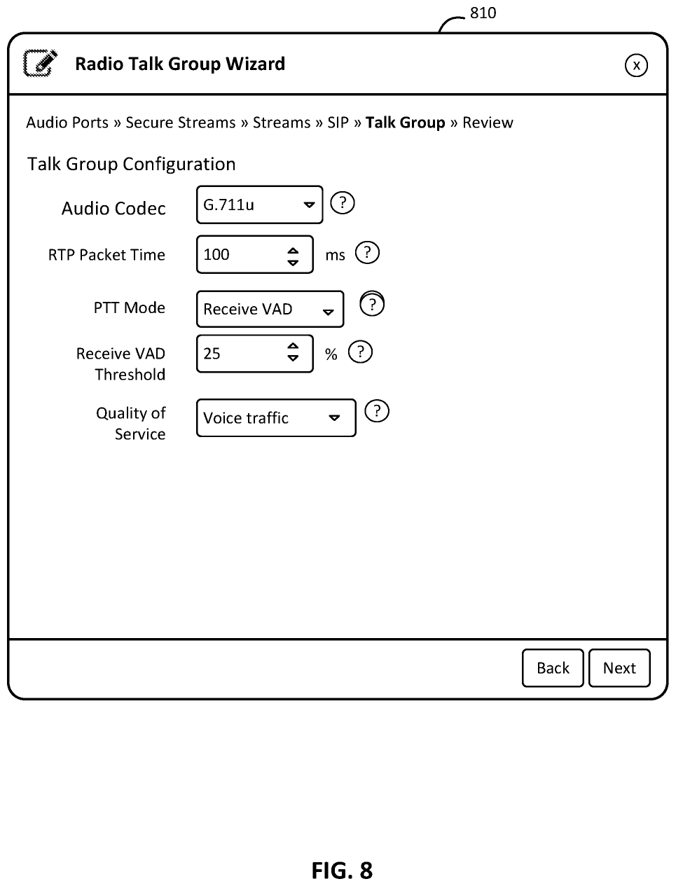

FIG. 8 is a screenshot of a “Talk Group” screen 810, that allows a user to input audio codec information for communication in the talk group. Here, various aspects of how the talk group will interface with the IP network may be configured. As illustrated, these options can include a selection of the Audio Codec, RTP Packet Time, PTT Mode, Quality of Service, and/or Receive Voice Activation Detection (VAD) Threshold. In alternative embodiments, the GUI may enable the user to input additional or alternative audio (and/or similar) settings.

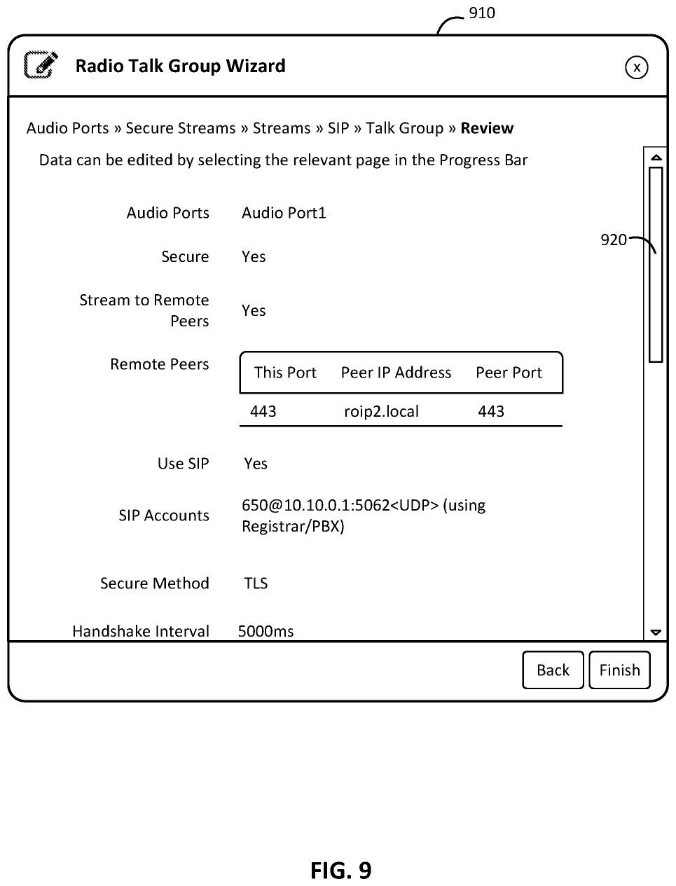

FIG. 9 is a screenshot of the “Review” screen 910. The Review screen 910 can show a summary of configuration information based on user input during the setup process. This allows the user to review the options before finishing the setup process. (Here, additional configuration information may be viewable by using the scrollbar 920 to scroll down.) Once the “finish” button is selected, the web form is submitted to the RoIP gateway device 110, and the corresponding talk group is created.

In some embodiments, selections made by a user in the various portions of the GUI may be collected and submitted as a web form to the RoIP gateway device 110, which then creates the talk group based on the selections in the web form. In such embodiments, the web form submission may be made in standard Hypertext Markup Language (HTML). Alternatively, the web form submission may be made via Extensible Markup Language (XML) and/or other formats. Although embodiments may utilize a single web form, it may be the result of a setup process involving portions (e.g., screens) of the GUI. Dividing the setup process into multiple screens may facilitate the setup for the user, providing separate screens for different aspects of the set up and presenting them to the user in a user-friendly way.

Once submitted, the web form may be sent to a web server that creates an Application Programming Interface (API) request to an API interface of the an application (e.g., the core software) of the RoIP gateway device 110, which reconfigures the RoIP gateway device 110 to create the talk group. (According to some embodiments, the web server may be hosted by the RoIP gateway device 110, in which case the web form would be passed from one piece of software (web server) executed by the RoIP gateway device 110 to another piece of software (the core software) executed by the RoIP gateway device 110.) Additionally, according to some embodiments, the web server that receives the web form submission may be the web server providing the GUI.

As illustrated in the figures above, embodiments utilizing a GUI in this manner can vastly simplify the setup of a talk group as compared with traditional forms of talk group configuration, which would often require adjusting different types of settings found in disparate parts of a user interface. In short, this is done by grouping the different devices that can talk together into logical groups (e.g., different audio ports and streams), and further providing a configuration process that proceeds through a series of screens that build upon each other in a logical manner. This can vastly improve the speed and ease with which a talk group can be configured, ultimately improving the user experience.

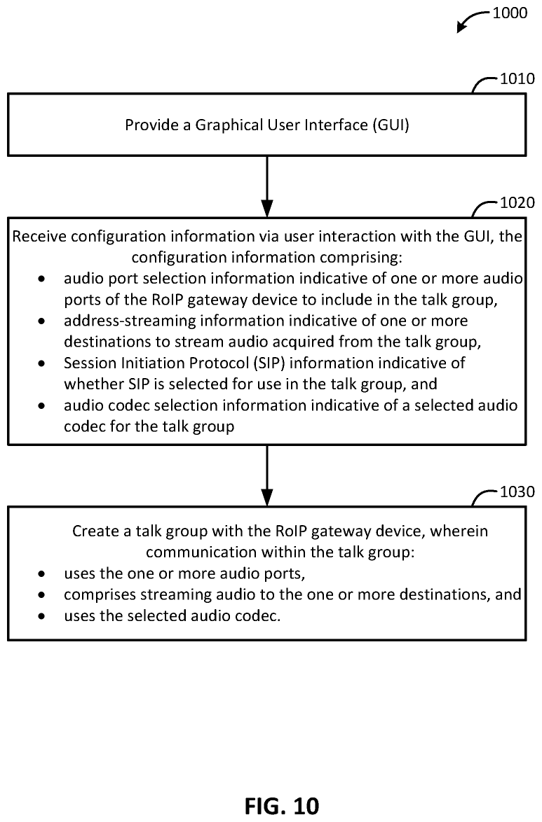

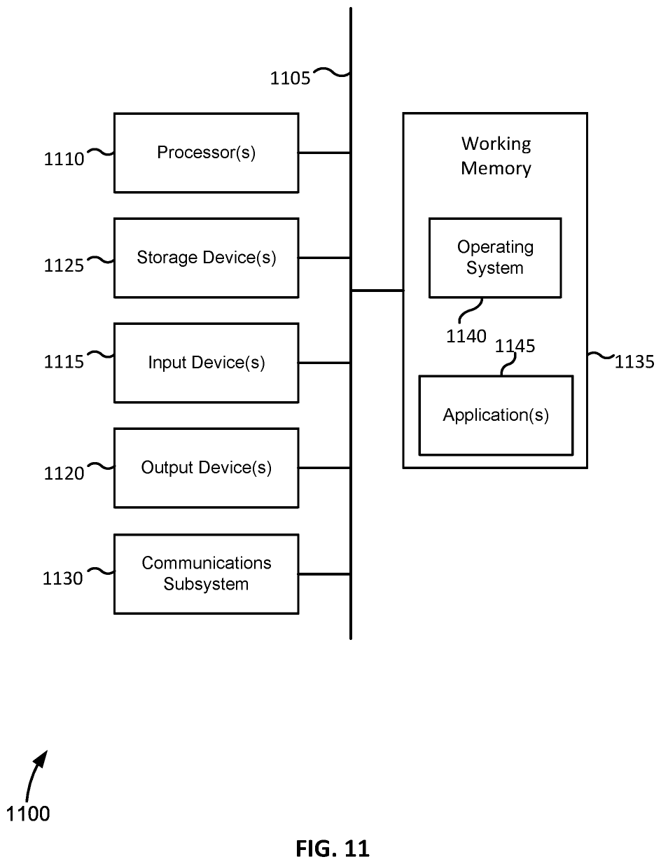

FIG. 10 is a flow diagram of a method 1000 of configuring a talk group with a RoIP gateway device, according to an embodiment. Means for performing the functions described in one or more blocks of FIG. 10 may include software and/or hardware components of a RoIP gateway device 110 which may incorporate and/or be incorporated into the computer system 1100 of FIG. 11, which is described in more detail below. Accordingly, the means for performing the functions of the method 1000 may include one or more of the components illustrated in FIG. 11.

At block 1010, the functionality comprises providing a GUI. As indicated in the previously-described embodiments, the GUI may be provided as a webpage, hosted by a web server. Moreover, the web server may be executed by the RoIP gateway device itself. According to some embodiments, the GUI may comprise a series of screens (e.g., a “setup wizard,” as shown in FIGS. 2A-9) to allow a user to easily enter settings to set up a talk group with the RoIP gateway device. Moreover, as noted, the GUI may provide additional options and/or restrict certain options based on prior user input.

The functionality at block 1020 comprises receiving configuration information via user interaction with the GUI. Here, the configuration information comprises (1) audio port selection information indicative of one or more audio ports of the RoIP gateway device to include in the talk group, (2) address-streaming information indicative of one or more destinations to stream audio acquired from the talk group, (3) SIP information indicative of whether SIP is selected for use in the talk group, and (4) audio codec selection information indicative of a selected audio codec for the talk group. As previously indicated, user selections regarding the talk group being set up, or previously-created talk groups on the RoIP gateway device, may restrict what a user is able to select when setting up the talk group. Accordingly, according to some embodiments, the method 1000 may further comprise restricting the audio port selection by the user within the GUI based on a determination that one or more audio ports of the RoIP gateway device are used by another talk group. Additionally or alternatively, the configuration information may further comprise security information applicable to the audio stream of the talk group, and the method may further comprise limiting the user's ability, in the GUI, to select a port for the one or more destinations to stream audio. In some embodiments, audio codec information may be further indicative of a user selection regarding an RTP, PTT mode, a receive VAD threshold, or any combination thereof. In some embodiments, receiving the configuration information may comprise receiving, at a web server, user input in a web form.

At block 1030, the functionality comprises creating a talk group with the RoIP gateway device, wherein communication within the talk group (1) uses the one or more audio ports, (2) comprises streaming audio to the one or more destinations, and (3) uses the selected audio codec. In some embodiments, the SIP information may indicate SIP is selected for use in the talk group. In such embodiments, the SIP information may further include SIP account information, and creating the talk group comprises using the SIP account information to set up SIP for the talk group. Additionally or alternatively, where user input is received via a web form, creating the talk group with the RoIP gateway device may further comprise providing the user input from the web server to a RoIP application executed by the RoIP gateway device.

FIG. 11 is a block diagram of simplified computer system 1100, according to some embodiments of the present disclosure. A computer system 1100 as illustrated in FIG. 11 may, for example, function as and/or be integrated into a RoIP gateway device 110, a PC executing software to emulate the functionality of a RoIP gateway device 110, and/or other devices as described herein, which may be capable of performing some or all of the functions of a RoIP gateway device 110 as described herein. FIG. 11 provides a schematic illustration of one embodiment of a computer system 1100 that can perform some or all of the steps of the methods provided by various embodiments. It should be noted that FIG. 11 is meant only to provide a generalized illustration of various components, any or all of which may be utilized as appropriate. FIG. 11, therefore, broadly illustrates how individual system elements may be implemented in a relatively separated or relatively more integrated manner.

The computer system 1100 is shown comprising hardware elements that can be electrically coupled via a bus 1105, or may otherwise be in communication, as appropriate. The hardware elements may include one or more processors 1110, including without limitation one or more general-purpose processors (e.g., CPUs) and/or one or more special-purpose processors such as digital signal processing chips, graphics acceleration processors (e.g., GPUs), and/or the like; one or more input devices 1115, which can include without limitation a mouse, a keyboard, a camera, and/or the like; and one or more output devices 1120, which can include without limitation a display device, a printer, and/or the like.

The computer system 1100 may further include and/or be in communication with one or more non-transitory storage devices 1125, which can comprise, without limitation, local and/or network accessible storage, and/or can include, without limitation, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The computer system 1100 might also include a communication subsystem 1130. For a computer system 1100 comprising a RoIP gateway device 110, the communications subsystem may comprise one or more audio ports, one or more USB ports, and a communication interface to enable the RoIP gateway device 110 to communicate with a media server, SIP PBX, and/or other remote devices and/or networks. As such, the communications subsystem 1130 may comprise without limitation a modem, a network card (wireless or wired), an infrared communication device, a wireless communication device, and/or a chipset, and/or the like.

The computer system 1100 also can include software elements, shown as being currently located within the working memory 1135, including an operating system 1140, device drivers, executable libraries, and/or other code, such as one or more application programs 1145, which may comprise computer programs provided by various embodiments (e.g., a web server, core software, etc.), and/or may be designed to implement methods, and/or configure systems, provided by other embodiments, as described herein. Merely by way of example, all or part of one or more procedures described with respect to the methods discussed above, and/or methods described in the claims, might be implemented as code and/or instructions executable by a computer and/or a processor within a computer. In an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 1125 described above. In some cases, the storage medium might be incorporated within a computer system, such as computer system 1100. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 1100 and/or might take the form of source and/or installable code, which, upon compilation and/or installation on the computer system 1100 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 1100 to perform methods in accordance with various embodiments of the technology. According to a set of embodiments, some or all of the procedures of such methods are performed by the computer system 1100 in response to processor(s) 1110 executing one or more sequences of one or more instructions, which might be incorporated into the operating system 1140 and/or other code, such as an application program 1145, contained in the working memory 1135. Such instructions may be read into the working memory 1135 from another computer-readable medium, such as one or more of the storage device(s) 1125. Merely by way of example, execution of the sequences of instructions contained in the working memory 1135 might cause the processor(s) 1110 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 1100, various computer-readable media might be involved in providing instructions/code to processor(s) 1110 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 1125. Volatile media include, without limitation, dynamic memory, such as the working memory 1135.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or

B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A method of configuring a talk group with a Radio-over-Internet-Protocol (RoIP) gateway device, the method comprising:
providing a Graphical User Interface (GUI);
receiving configuration information via user interaction with the GUI, the configuration information comprising:
audio port selection information indicative of one or more audio ports of the RoIP gateway device to include in the talk group,
address-streaming information indicative of one or more destinations to which an audio stream of the talk group is to be sent,
Session Initiation Protocol (SIP) information indicative of whether SIP is selected for use in the talk group, and
audio codec information indicative of a selected audio codec for the talk group; and
creating a talk group with the RoW gateway device, wherein communication within the talk group:
uses the one or more audio ports,
comprises streaming audio to the one or more destinations, and
uses the selected audio codec.

2. The method of claim 1, wherein the SIP information indicates SIP is selected for use in the talk group and further includes SIP account information, and wherein creating the talk group comprises using the SIP account information to set up SIP for the talk group.

3. The method of claim 1, further comprising restricting audio port selection by a user within the GUI based on a determination that one or more audio ports of the RoW gateway device are used by another talk group.

4. The method of claim 1, wherein the configuration information further comprises security information applicable to the audio stream of the talk group, and wherein the method further comprises limiting a user's ability, in the GUI, to select a port for the one or more destinations to stream audio.

5. The method of claim 1, wherein the audio codec information is further indicative of a user selection regarding an Real-time Transport Protocol RTP, a Push-To-Talk (PTT) mode, a receive voice activation detection (VAD) threshold, or any combination thereof.

6. The method of claim 1, wherein receiving the configuration information comprises receiving, at a web server, user input in a web form.

7. The method of claim 6, wherein creating the talk group with the RoIP gateway device further comprises providing the user input from the web server to a RoIP application executed by the RoIP gateway device.

8. A Radio-over-Internet-Protocol (RoIP) gateway device comprising:
a communications subsystem;
a memory; and
one or more processors communicatively coupled with the memory and communications system, wherein the one or more processors are configured to:
provide a Graphical User Interface (GUI);
receive configuration information via user interaction with the GUI, the configuration information comprising:
audio port selection information indicative of one or more audio ports of the RoIP gateway device to include in a talk group,
address-streaming information indicative of one or more destinations to which an audio stream of the talk group is to be sent,
Session Initiation Protocol (SIP) information indicative of whether SIP is selected for use in the talk group, and
audio codec information indicative of a selected audio codec for the talk group; and
create a talk group using the communications subsystem such that communication within the talk group:
uses the one or more audio ports,
comprises streaming audio to the one or more destinations, and
uses the selected audio codec.

9. The RoIP gateway device of claim 8, wherein the one or more processors are configured to receive, in the SIP information:
an indication that SIP is selected for use in the talk group, and
SIP account information;
and wherein, to create the talk group, the one or more processors are further configured to use the SIP account information to set up SIP for the talk group.

10. The RoIP gateway device of claim 8, wherein the one or more processors are further configured to restrict audio port selection by a user within the GUI based on a determination that one or more audio ports of the RoIP gateway device are used by another talk group.

11. The RoIP gateway device of claim 8, wherein:
the one or more processors are configured to receive, in the configuration information, security information applicable to the audio stream of the talk group; and
the one or more processors are further configured to limit a user's ability, in the GUI, to select a port for the one or more destinations to stream audio.

12. The RoIP gateway device of claim 8, wherein the one or more processors are configured to receive, in the audio codec information, an indication of a user selection regarding an Real-time Transport Protocol RTP, a Push-To-Talk (PTT) mode, a receive voice activation detection (VAD) threshold, or any combination thereof

13. The RoIP gateway device of claim 8, wherein, to receive the configuration information, the one or more processors are configured to receive, at a web server, user input in a web form.

14. The RoIP gateway device of claim 13, wherein, to create the talk group, the one or more processors are further configured to provide the user input from the web server to a RoIP application executed by the RoIP gateway device.

15. A non-transitory computer-readable medium having instructions stored thereby for operating a Radio-over-Internet-Protocol (RoIP) gateway device, wherein the instructions, when executed by one or more processors, cause the one or more processors to:
provide a Graphical User Interface (GUI);
receive configuration information via user interaction with the GUI, the configuration information comprising:
audio port selection information indicative of one or more audio ports of the RoIP gateway device to include in a talk group,
address-streaming information indicative of one or more destinations to which an audio stream of the talk group is to be sent,
Session Initiation Protocol (SIP) information indicative of whether SIP is selected for use in the talk group, and
audio codec information indicative of a selected audio codec for the talk group; and
create a talk group using the RoIP gateway device such that communication within the talk group:
uses the one or more audio ports,
comprises streaming audio to the one or more destinations, and
uses the selected audio codec.

16. The non-transitory computer-readable medium of claim 15, wherein the instructions, when executed by the one or more processors, further cause the one or more processors to receive, in the SIP information:
an indication that SIP is selected for use in the talk group, and
SIP account information;
and wherein, to create the talk group, the instructions, when executed by the one or more processors, further cause the one or more processors to use the SIP account information to set up SIP for the talk group.

17. The non-transitory computer-readable medium of claim 15, the instructions, when executed by the one or more processors, further cause the one or more processors to restrict audio port selection by a user within the GUI based on a determination that one or more audio ports of the RoW gateway device are used by another talk group.

18. The non-transitory computer-readable medium of claim 15, wherein the instructions, when executed by the one or more processors, further cause the one or more processors to:
receive, in the configuration information, security information applicable to the audio stream of the talk group; and
limit a user's ability, in the GUI, to select a port for the one or more destinations to stream audio.

19. The non-transitory computer-readable medium of claim 15, wherein the instructions, when executed by the one or more processors, further cause the one or more processors to receive, in the audio codec information, an indication of a user selection regarding an Real-time Transport Protocol RTP, a Push-To-Talk (PTT) mode, a receive voice activation detection (VAD) threshold, or any combination thereof

20. The non-transitory computer-readable medium of claim 15, wherein, to receive the configuration information, the instructions, when executed by the one or more processors, further cause the one or more processors to receive, at a web server, user input in a web form.
